(19) United States
(12) Patent Application Publication
(10) Pub. No.: US 2007/0290821 A1
(43) Pub. Date: Dec. 20, 2007

(54) Side alarm for vehicles

(76) Inventor: Shun-Fu Lin, Taipei (TW)

Correspondence Address: POSZ LAW GROUP, PLC, 12040 SOUTH LAKES DRIVE, SUITE 101, RESTON, VA, 20191, US

(21) Appl. No.: 11/453,203

(22) Filed: Jun. 15, 2006

(51) Int. Cl. B60Q 1/00; H04N 7/18

(52) U.S. Cl. 340/435; 348/148

(57) ABSTRACT

A side alarm for vehicles has a post mounted in a front side of the vehicle; and at least one monitor mounted on the post. In usage, the monitor can be pivoted manually and is connected to a screen in the vehicle. When the monitor is switched on, the monitor can shoot the scene outside of the vehicle. The scene of the monitor is transferred to display on the screen in the vehicle so that a driver can monitor the road condition by the screen to avoid the car accident.

### BACKGROUND OF THE INVENTION

1. Field of the Invention

The present invention relates to a side alarm for vehicles, and more particularly to a side alarm with which a driver in the vehicle can monitor dead spot of view.

2. Description of the Related Art

While driving, a driver monitors the road condition via rearview mirror and outside mirrors to ensure the driving safety.

With reference to FIG. 10, the driver uses a conventional outside mirror (60) to see the dead spot. However, the driver's view is not clear when the outside mirror (60) is covered with water or mist in raining days. Furthermore, driver's view can be intervened by obstacles during other vehicles passing by such that it is easy to cause vehicle collision or human damage.

Side alarm Reversing sensors are mounted at the rear end of the vehicle to monitor the rear condition when the vehicle moves backward. However, the reversing sensors are only helpful when the vehicle moves backward. Furthermore, the image display of the reversing sensor is at the front of the vehicle. When the vehicle moves backward, the driver has to look the back of the vehicle and to look the image display of the reversing sensor at the front of the vehicle. It is inconvenient for the driver to turn the head frontward or backward.

Side sensors are mounted respectively on the outside mirrors to shoot the road condition. Via wires, the scene of the side sensors is transferred to a screen provided in the vehicle to monitor the road condition at the rear and side of the vehicle. However, the driver cannot directly adjust the side sensors and the visual angles of the side sensors are limited by the outside mirrors. The driver can only adjust the side sensors by adjusting the outside mirrors. Therefore, in some cases the side sensors are hard to monitor the road condition in time.

Therefore, the invention provides a side alarm for vehicles to mitigate or obviate the aforementioned problems.

### SUMMARY OF THE INVENTION

The main objective of the present invention is to provide a side alarm that can monitor the dead angle to ensure the driving safety.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a side alarm for vehicles in accordance with the present invention with a partial view of a vehicle;

FIG. 2 is a perspective view of a second embodiment of a side alarm for vehicles in accordance with the present invention with a partial view of a vehicle;

FIG. 3 is a perspective view of a third embodiment of a side alarm for vehicles in accordance with the present invention with a partial view of a vehicle;

FIG. 4 is a perspective view of a fourth embodiment of a side alarm for vehicles in accordance with the present invention with a partial view of a vehicle;

FIG. 5 is a side view in partial section of the side alarm for vehicles in FIG. 4;

FIG. 6 is an enlarged top view of the side alarm for vehicles in FIG. 4 with a partial view of a vehicle;

FIG. 7 is a side view in partial section of a fifth embodiment of the side alarm for vehicles in accordance with the present invention;

FIG. 8 is an operational top view of the side alarm for vehicles in FIG. 7;

FIG. 9 is an enlarged top view of the side alarm for vehicles in FIG. 7 with a partial view of a vehicle; and

FIG. 10 is an operational top view of a vehicle with side view mirrors in accordance with the prior art.

### DETAILED DESCRIPTION OF THE PREFERRED EMBODIMENT

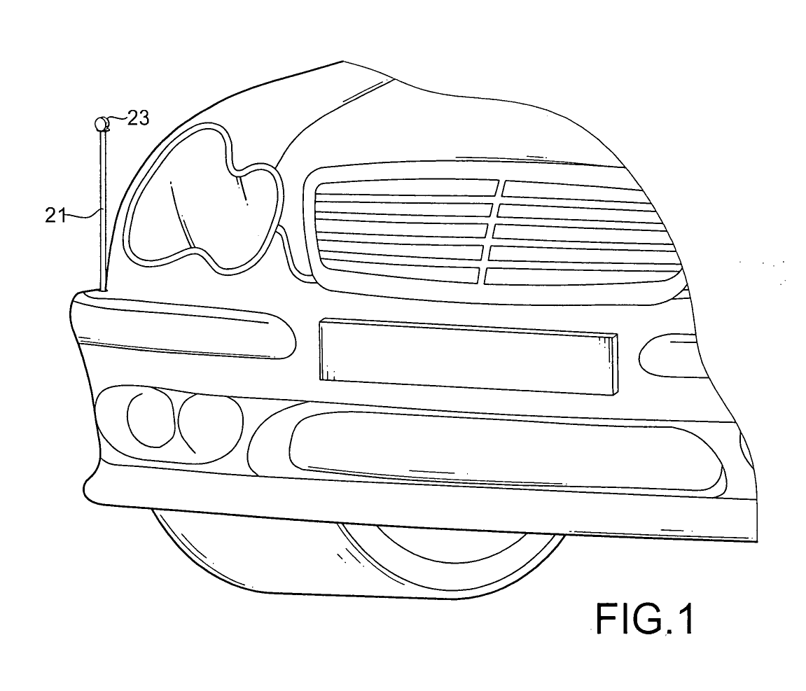

With reference to FIG. 1, a first embodiment of a side alarm for vehicles in accordance with the present invention comprises a post (21) mounted on a front side of a vehicle and a first monitor (23) mounted on a top end of the post (21).

In usage, the first monitor (23) can be pivoted manually and is connected to a screen in the vehicle. When the first monitor (23) is switched on, the first monitor (23) can shoot the scene outside of the vehicle. The scene of first monitor (23) is transferred to display on the screen in the vehicle so that a driver can monitor the road condition by the screen to avoid the car accident.

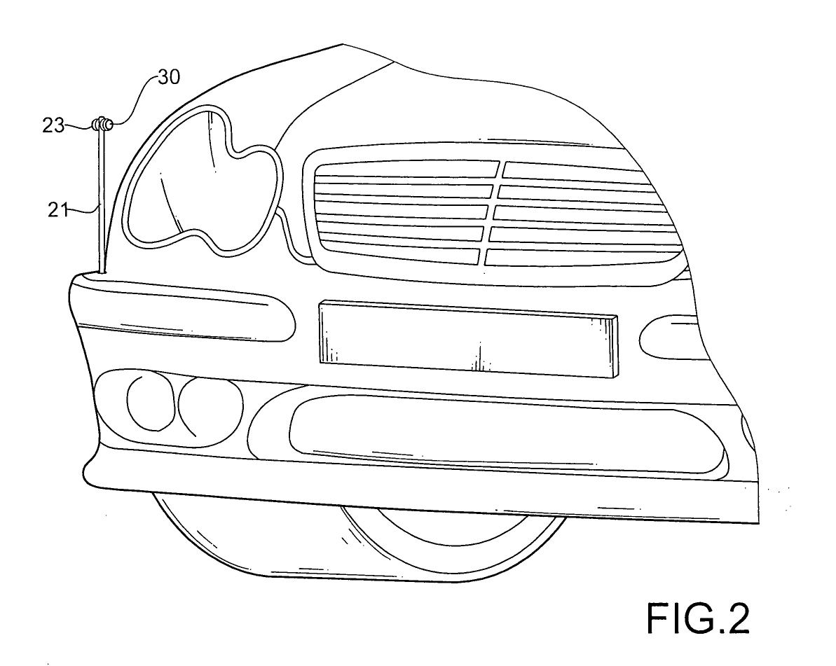

With further reference to FIG. 2, a second embodiment of a side alarm for vehicles in accordance with the present invention comprises a post (21), a first monitor (23) and a second monitor (30). The post (21) is mounted on the front side of the vehicle. The first monitor (23) and the second monitor (30) are mounted respectively on the top end of the post (21).

In usage, the first and the second monitor (23, 30) can be pivoted manually and are connected to the screen in the vehicle. When the first and second monitors (23, 30) are switched on, the first and second monitors (23, 30) can shoot the scene at the left and the right of the front sides of the vehicle. The scene of the first and second monitors (23, 30) is transferred to display on the screen in the vehicles so that a driver can monitor the road condition by the screen to avoid the vehicle accident.

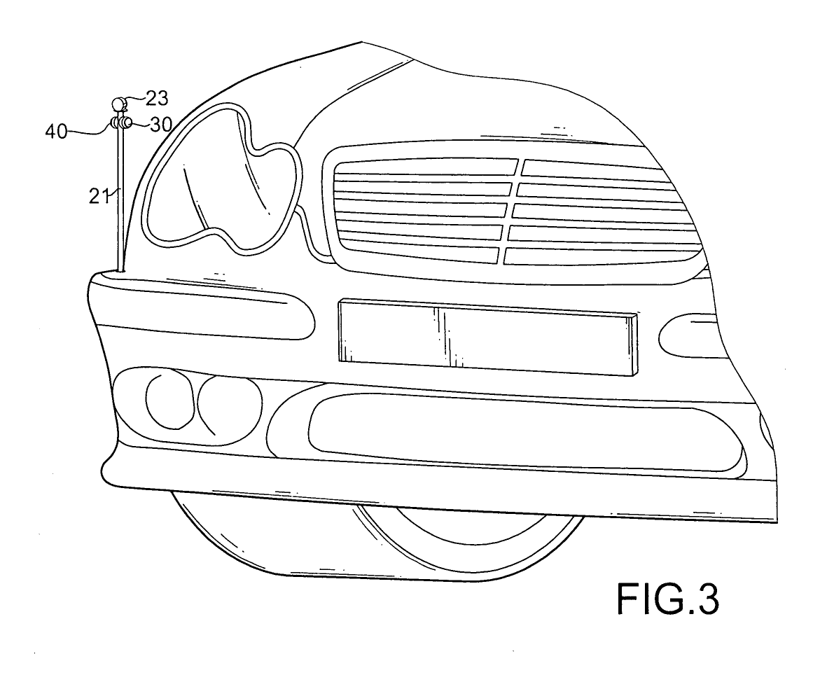

With further reference to FIG. 3, a third embodiment of a side alarm for vehicles in accordance with the present invention comprises a post (21), a first monitor (23), a second monitor (30) and a third monitor (40). The post (21) is mounted on the front side of the vehicle. The first monitor (23) is mounted on the top end of the post (21). The second monitor (30) and the third monitor (40) are mounted respectively on the post (21) below the first monitor (23) and align with each other.

In usage, the first, second and third monitors (23, 30, 40) can be pivoted manually and are connected to the screen in the vehicle. When the first, second and third monitors (23, 30, 40) are switched on, the first monitor (23) can shoot the scene at the right of the rear side of the vehicle and the second and third monitors (30, 40) can shoot the scene left and the right of the front sides of the vehicle. The scene of the first, second and third monitors (23, 30, 40) are transferred to display on the screen in the vehicle so that a driver can monitor the road condition by the screen to avoid the car accident.

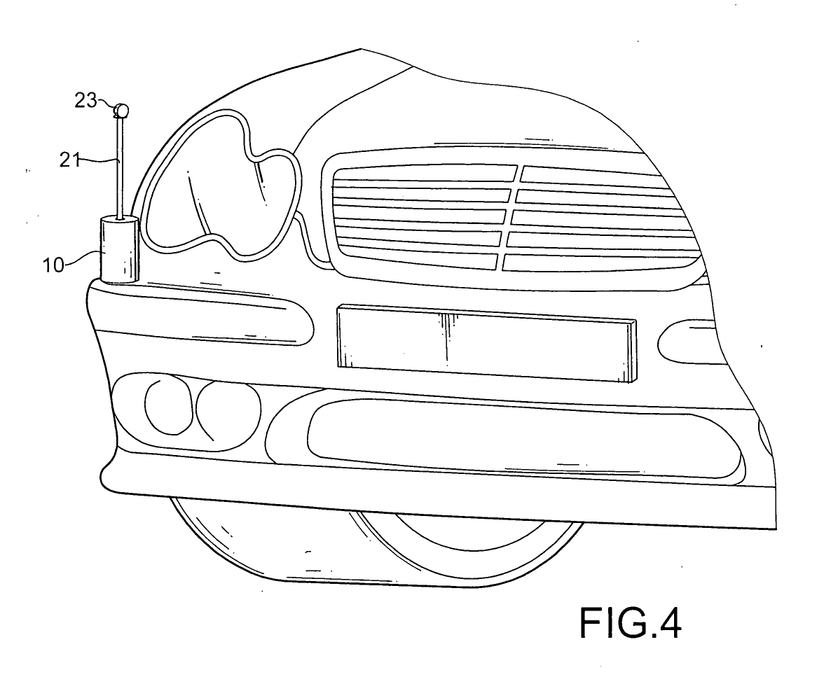

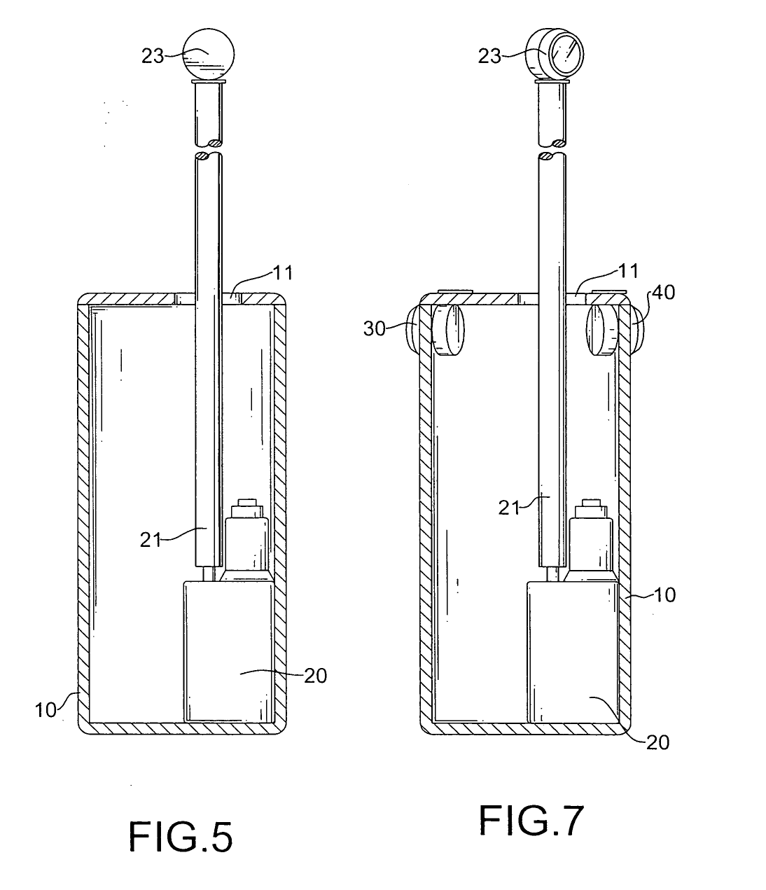

With further reference to FIGS. 4 and 5, a fourth embodiment of a side alarm for vehicles in accordance with the present invention has a barrel (10), a driving member (20), a post (21) and a first monitor (23). The barrel (10) is mounted on the front side of the vehicle and has a vent (11) defined in the barrel (10). The driving member (20) is mounted in the barrel (10). The post (21) is mounted on a top end of the driving member (20), extends through the vent (11) and extends out of the barrel (10). The first monitor (23) is mounted securely on the top end of the post (21) and is connected to the screen in the vehicle.

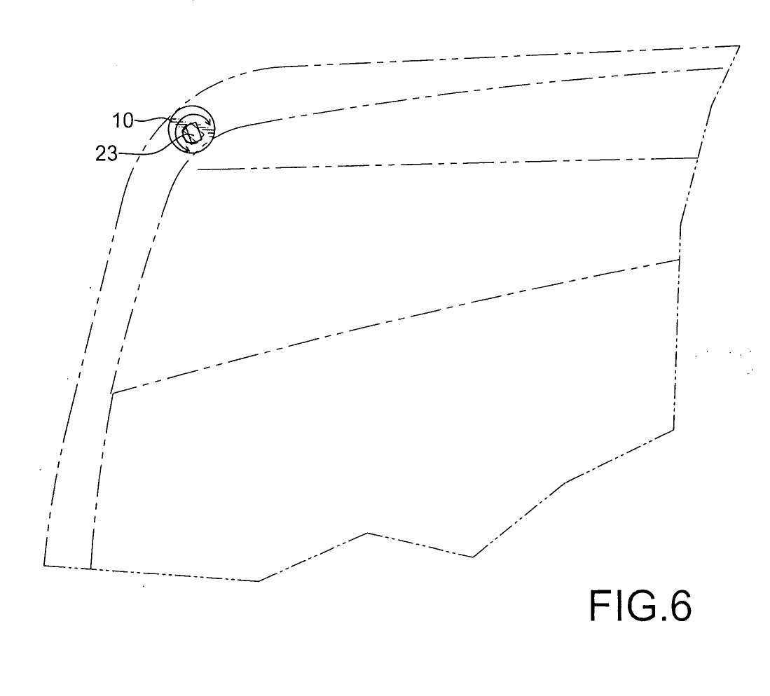

With further reference to FIG. 6, the post (21) is rotated by the driving member (20). When the first monitor (23) is switched on, the first monitor (23) can shoot the scene at the right and the left of the front side of the vehicle to avoid car accident.

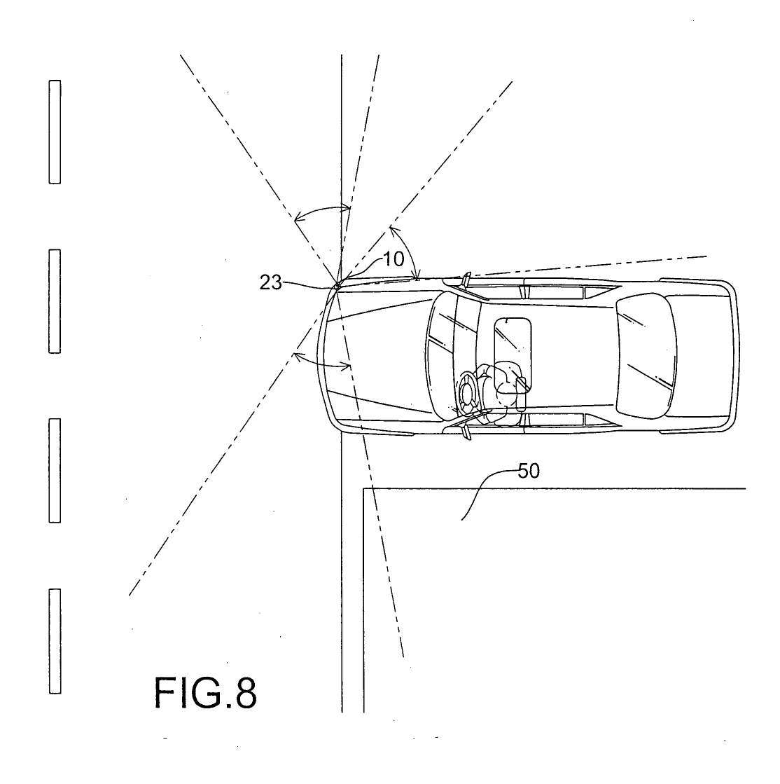

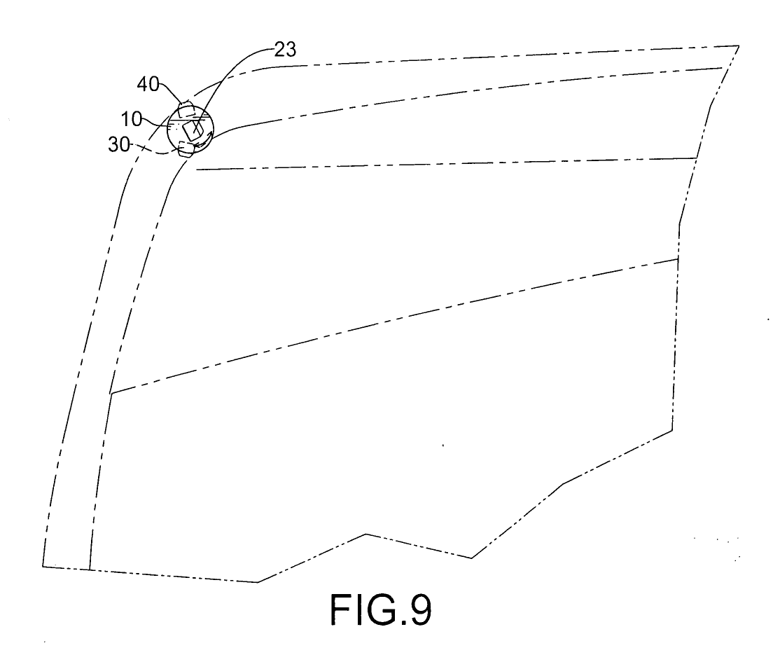

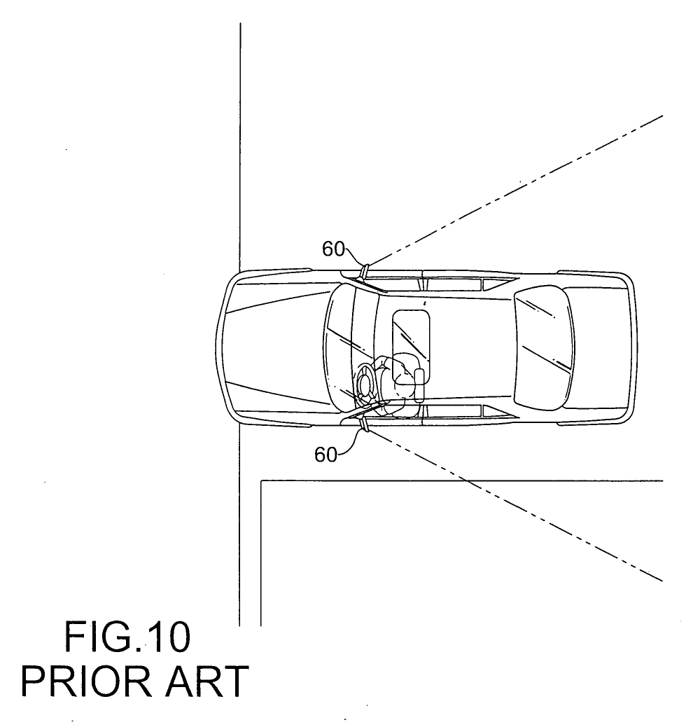

With further reference to FIGS. 7-9, the fifth embodiment of a side alarm for vehicles in accordance with the present invention is similar to the fourth embodiment and further comprises a second monitor (30) and a third monitor (40). The second and third monitors (30, 40) are mounted respectively on two sides of the barrel (20) below the first monitor (23) and align with each other. The first, second and third monitors are connected to the screen in the vehicle.

In usage, the first monitor (23) can be pivoted by the driving member (20) and the second and third monitors (30, 40) can be pivoted manually. When the first, second the third monitors (23, 30, 40) are switched on, the first monitor (23) can shoot the scene at the right of the rear side of the vehicle and the second and third monitors (30, 40) can shoot the scene at the left and the right of the front sides of the vehicle. The scene of the first, second and third monitors (23, 30, 40) is transferred to display on the screen in the vehicles so that a driver can monitor the road condition by the screen to avoid the vehicle accident.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A side alarm for vehicles with a front side comprising:
a post adapted to be mounted on the front side of the vehicle; and
a first monitor mounted on the post.

2. The side alarm as claimed in claim 1 further comprising a second monitor mounted on the post.

3. The side alarm as claimed in claim 1 further comprising a third monitor mounted on the post.

4. The side alarm for vehicles as claimed in claim 1, wherein
a barrel is mounted around the post and adapted to be mounted in the front side of the vehicle;
a driving member is mounted in the barrel and connects to and pivots the post; and
the post extends out of the barrel.

5. The side alarm for vehicles as claimed in claim 4, wherein a second and a third monitor are mounted respectively on a top end of the barrel.

6. The side alarm for vehicles as claimed in claim 3, wherein the first monitor is mounted on a top end of the post, the second monitor and the third monitor are mounted respectively on the post below the first monitor and aligning with each other.
